(19) United States
(12) Patent Application Publication
(10) Pub. No.: US 2025/0283358 A1
(43) Pub. Date: Sep. 11, 2025

(54) VEHICLE COMPONENT ACCESS METHOD

(71) Applicant: Ford Global Technologies, LLC, Dearborn, MI (US)

(72) Inventors: Brian Purcell, Trenton, MI (US); Matthew Francis O'Hagan, La Canada Flintridge, CA (US); Cesar Adolfo Prieto Sanchez, Mexico City (MX); Kevin Robert Chauvin, Belleville, MI (US)

(21) Appl. No.: 18/601,175

(22) Filed: Mar. 11, 2024

(51) Int. Cl. E05B 83/24; B60R 19/52

(52) U.S. Cl. CPC E05B 83/24; B60R 2019/525

(57) ABSTRACT

A vehicle component access method includes unlatching a hood latch of a vehicle, and the opening a hood to access a compartment of the vehicle. The method further includes unlatching a grille latch from within the compartment; and moving a grille to access a component aft of the grille.

### TECHNICAL FIELD

This disclosure relates generally to accessing a component of a vehicle, and more particularly, to accessing the component by moving a grille.

### BACKGROUND

Vehicles include various components. From time to time, components may need to be accessed for cleaning, maintenance, or for some other reason.

### SUMMARY

In some aspects, the techniques described herein relate to a vehicle component access method, including: unlatching a hood latch of a vehicle; opening a hood to access a compartment of the vehicle. unlatching a grille latch from within the compartment; and moving a grille to access a component aft of the grille.

In some aspects, the techniques described herein relate to a vehicle component access method, wherein moving the grille includes pulling the grille forward from the vehicle.

In some aspects, the techniques described herein relate to a vehicle component access method, wherein the unlatching of the hood latch is from within a passenger compartment of the vehicle.

In some aspects, the techniques described herein relate to a vehicle component access method, wherein moving the grille includes pivoting the grille from an operational position to an access position.

In some aspects, the techniques described herein relate to a vehicle component access method, wherein moving the grille includes pivoting the grille about a bottom lower edge of the grille.

In some aspects, the techniques described herein relate to a vehicle component access method, wherein the grille guides a flow of air to the component.

In some aspects, the techniques described herein relate to a vehicle component access method, wherein the grille latch is inaccessible from outside the compartment.

In some aspects, the techniques described herein relate to a vehicle component access method, wherein the compartment is an engine compartment.

In some aspects, the techniques described herein relate to a vehicle component access method, wherein the component is a radiator.

In some aspects, the techniques described herein relate to a vehicle component access method, wherein the component is a Heating Ventilation Air Conditioning component.

In some aspects, the techniques described herein relate to a vehicle component access system, including: a hood that can move between a closed position and an open position, the hood in the closed position covering an opening to an engine compartment of a vehicle such that the engine compartment is inaccessible through the opening, the engine compartment accessible through the opening when the hood is in the open position; a grille that can move between an operational position and an access position; and a grille latch that holds the grille in the operational position when the grille latch is engaged, the grille movable from the operational position to the access position when the grille latch is disengaged, the grille latch accessible from within the engine compartment.

In some aspects, the techniques described herein relate to a vehicle component access system, wherein the grille is pivotable coupled to another portion of the vehicle.

In some aspects, the techniques described herein relate to a vehicle component access system, further including at least one damper connected to the grille and the other portion of the vehicle.

In some aspects, the techniques described herein relate to a vehicle component access system, further including an actuator of the grille latch, the actuator within the engine compartment.

In some aspects, the techniques described herein relate to a vehicle component access system, wherein the grille latch is accessible from within the engine compartment when the hood is in the open position.

In some aspects, the techniques described herein relate to a vehicle component access system, wherein the grille is at a front end of the vehicle.

In some aspects, the techniques described herein relate to a vehicle component access system, further including a component aft of the grille, the component accessible when the grille is in the access position.

In some aspects, the techniques described herein relate to a vehicle component access system, wherein the component is a Heating Ventilation and Air Conditioning component.

In some aspects, the techniques described herein relate to a vehicle component access system, wherein the component is a radiator.

In some aspects, the techniques described herein relate to a vehicle component access system, further including an actuator for a hood latch, the actuator disposed within a passenger compartment of the vehicle.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of a vehicle having a hood and a grille.

FIG. 2 illustrates the vehicle of FIG. 1 with the hood in an open position, and the grille in an access position.

FIG. 3 illustrates a highly schematic view of the vehicle of FIG. 1.

FIG. 4 illustrates a flow of an example vehicle component access method according to an exemplary aspect of the present disclosure.

### DETAILED DESCRIPTION

This disclosure details a vehicle component access method that involves moving a grille of a vehicle. Moving the grille provides access to a component that is aft the grille. Access to the component may be needed so that the component can be cleaned. The component can be a radiator, for example.

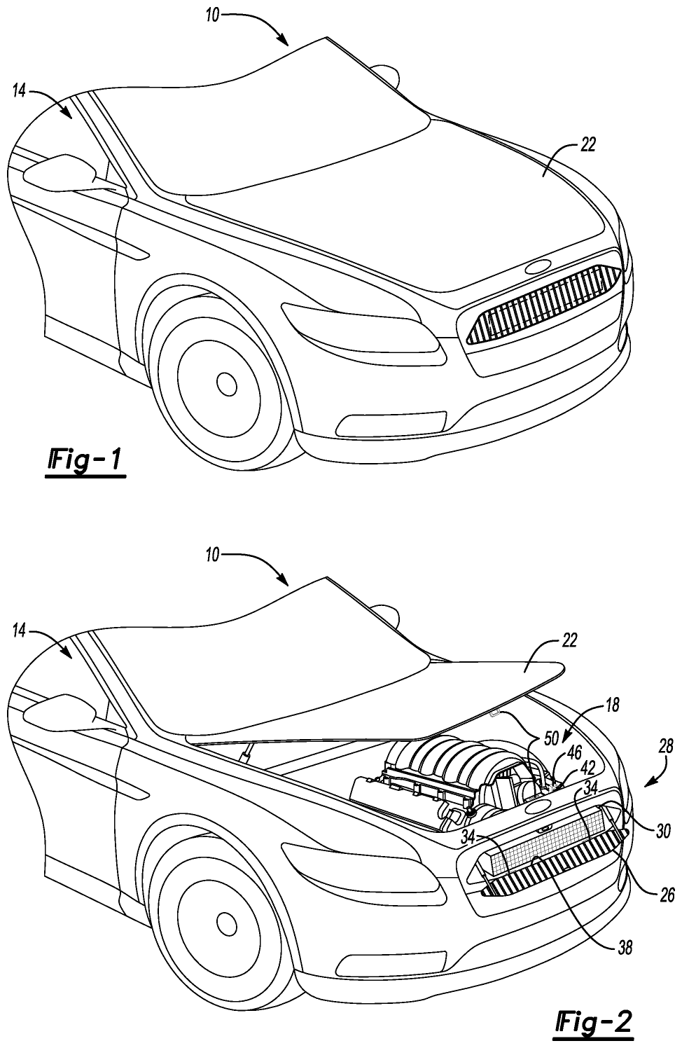

With reference to FIGS. 1 and 2, an example vehicle 10 includes a passenger compartment 14 and an engine compartment 18. FIG. 1 shows a hood 22 in a closed position where the hood 22 covers the engine compartment 18. FIG. 2 shows the hood in an open position to provide access to the engine compartment 18.

A grille 26 is disposed at a front end 28 of the vehicle 10. Aft the grille 26 is a component 30 of the vehicle 10. The component 30, in the exemplary embodiment, is a radiator of the vehicle 10. In another example, the component 30 could be another type of component, such as another Heating Ventilation Air Conditioning (HVAC) component.

FIG. 1 shows the grille 26 in an operational position, which is how the grille 26 is positioned during ordinary operation. In this position, the grille 26 guides a flow of air to the component 30 when in the operational position.

The grille 26 in the operational position inhibits access to the component 30. From time to time, access to the component 30 may be required. For example, cleaning the component may be required. Thus, in this example, the grille 26 can be pivoted from the operational position shown in FIG. 1 to the access position shown in FIG. 2. In the access position, the component 30 can be accessed for cleaning, repair, inspection, etc. without being blocked by the grille 26.

Hinges 34 can couple the grille 26 to another portion of the vehicle 10. In this example, two hinges 34 pivotably connect the grille 26 to the other portion of the vehicle 10. Moving the grille 26 from the operational position of FIG. 1 to the access position of FIG. 2 involves pivoting the example grille 26 about a bottom lower edge 38 of the grille 26.

One or more lift supports or dampers support the grille 26 in the access position of FIG. 2 and help to control movement of the grille 26 back-and-forth between the operational position and the access position.

A grille latch 42, when latched, maintains the grille 26 in the operational position. The grille latch 42 includes an actuator 46 that can be manipulated by a user to transition the grille latch 42 from the latched state to an unlatched state. Notably, at least the actuator 46 of the grille latch 42 is disposed in the engine compartment 18.

The actuator 46 can be, for example, a release lever that a user desirous of moving the grille 26 to the access position must actuate to release the grille latch 42 such that the grille 26 can pivot from the operational position to the access position. Provided the grille latch 42 is unlatched, the grille 26 can move to the access position in response to a user pulling the grille 26 forward from the vehicle 10.

In this example, the actuator 46 for the grille latch 42 is inaccessible from outside the engine compartment 18. Keeping the actuator 46 of the grille latch 42 within the engine compartment 18 means that the user desirous of moving the grille 26 to the access position must have access to the engine compartment 18, which requires opening the hood 22.

In this example, a hood latch 50 holds the hood 22 in the closed position of FIG. 1. If access to the engine compartment 18 is desired, the hood latch 50 must be released so that the hood 22 can pivot to the position of FIG. 2.

While the actuator 46 of the grille latch 42 is within the engine compartment 18 in this example, the hood latch 50 could be disposed in other compartments of the vehicle 10 in other examples. For example, the vehicle 10 could be an all-electric vehicle having a frunk, and the actuator could be disposed within the frunk.

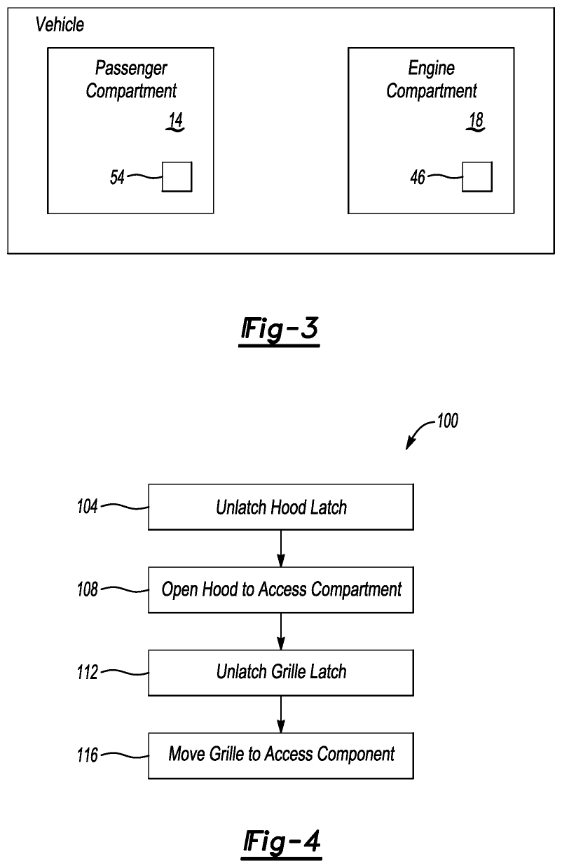

With reference now to FIG. 3 and continuing reference to FIGS. 1 and 2, in this example, an actuator 54 for the hood latch 50 is disposed within the passenger compartment 14. Transitioning the hood latch 50 to a disengaged position thus, in this example, requires access to the passenger compartment 14 and, in particular, the actuator 54 that is within the passenger compartment 14.

In the example embodiment, releasing the hood latch 50 occurs by authorized users-those users that can access the passenger compartment 14. Since the hood latch 50 is actuated by an authorized user, the actuator 46 for the grille latch 42 is only accessible to the authorized user. This is because opening the hood 22 is required to access the actuator 46 for the grille latch 42.

In other examples, the actuator 54 for the hood latch 50 could be outside the passenger compartment 14, but can still require some level of authorization. Such the actuator could be an virtual actuator on user smartphone or key fob, for example.

With reference now to FIG. 4, an example vehicle component access method 100 begins at a step 104, which includes unlatching a hood latch of a vehicle. Next, at a step 108, the method 100 opens a hood to access a compartment of the vehicle. At a step 112, the method 100 includes unlatching a grille latch from within the compartment. The method 100 then moves a grille to access a component that is aft of the grille at a step 116.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle component access method, comprising:
unlatching a hood latch of a vehicle;
opening a hood to access a compartment of the vehicle;
unlatching a grille latch from within the compartment; and
moving a grille to access a component aft of the grille.

2. The vehicle component access method of claim 1, wherein moving the grille comprises pulling the grille forward from the vehicle.

3. The vehicle component access method of claim 1, wherein the unlatching of the hood latch is from within a passenger compartment of the vehicle.

4. The vehicle component access method of claim 1, wherein moving the grille comprises pivoting the grille from an operational position to an access position.

5. The vehicle component access method of claim 1, wherein moving the grille comprises pivoting the grille about a bottom lower edge of the grille.

6. The vehicle component access method of claim 1, wherein the grille guides a flow of air to the component.

7. The vehicle component access method of claim 1, wherein the grille latch is inaccessible from outside the compartment.

8. The vehicle component access method of claim 1, wherein the compartment is an engine compartment.

9. The vehicle component access method of claim 1, wherein the component is a radiator.

10. The vehicle component access method of claim 1, wherein the component is a Heating Ventilation Air Conditioning component.

11. A vehicle component access system, comprising:
a hood that can move between a closed position and an open position, the hood in the closed position covering an opening to an engine compartment of a vehicle such that the engine compartment is inaccessible through the opening, the engine compartment accessible through the opening when the hood is in the open position;
a grille that can move between a operational position and an access position; and
a grille latch that holds the grille in the operational position when the grille latch is engaged, the grille movable from the operational position to the access position when the grille latch is disengaged, the grille latch accessible from within the engine compartment.

12. The vehicle component access system of claim 11, wherein the grille is pivotable coupled to another portion of the vehicle.

13. The vehicle component access system of claim 12, further comprising at least one damper connected to the grille and the other portion of the vehicle.

14. The vehicle component access system of claim 11, further comprising an actuator of the grille latch, the actuator within the engine compartment.

15. The vehicle component access system of claim 11, wherein the grille latch is accessible from within the engine compartment when the hood is in the open position.

16. The vehicle component access system of claim 11, wherein the grille is at a front end of the vehicle.

17. The vehicle component access system of claim 11, further comprising a component aft of the grille, the component accessible when the grille is in the access position.

18. The vehicle component access system of claim 17, wherein the component is a Heating Ventilation and Air Conditioning component.

19. The vehicle component access system of claim 17, wherein the component is a radiator.

20. The vehicle component access system of claim 11, further comprising an actuator for a hood latch, the actuator disposed within a passenger compartment of the vehicle.
